(19) United States
(12) Patent Application Publication
(10) Pub. No.: US 2011/0246331 A1
(43) Pub. Date: Oct. 6, 2011

(54) Online Custom Circuit Marketplace

(76) Inventors: Erik B. Luther, Round Rock, TX (US); Vincent Accardi, Toronto (CA)

(21) Appl. No.: 12/754,668

(22) Filed: Apr. 6, 2010

(51) Int. Cl. G06Q 50/00; G06Q 30/00; G06F 3/01; G06F 17/50; G06Q 20/00

(52) U.S. Cl. 705/27.1; 715/760; 716/100; 705/26.63

(57) ABSTRACT

Network-based system and method for providing custom circuits to customers. At least one computer may be used to perform the method. A specification of a custom circuit may be received from at least one first user over a wide area network. The specification may specify a design of the custom circuit. Information regarding the custom circuit may be provided on a website over the wide area network. At least one purchase order of the custom circuit may be received from at least one second user over the wide area network. The purchase order(s) may include delivery information for the custom circuit. Delivery of the custom circuit may be configured based on the purchase order(s). The first user(s) may receive payment based on the purchase order(s).

### FIELD OF THE INVENTION

The present invention relates to network-based commerce, and more specifically to a method for providing an online marketplace for custom circuits.

### DESCRIPTION OF THE RELATED ART

Circuit design is complicated, and existing infrastructure is geared toward production volumes and/or high cost specialty circuits. At lower volumes, inexpensive circuits are unprofitable because the net cost of processing is too high. Accordingly, a way of providing low cost circuits at small order sizes would be desirable.

In different industries, the concept of print-on-demand has become popular as a means of providing low volumes of niche products at reasonable prices. In particular, with the development of digital printing, the publishing industry has embraced the print-on-demand concept; similarly, Café Press™ has developed an online market for printing custom designs on various consumer goods. However, because of the numerous services and specialized expertise necessary to design and produce custom circuits, developing a model for an online marketplace for custom circuits is a non-trivial endeavor.

### SUMMARY OF THE INVENTION

Various embodiments are presented of a system and method for providing custom circuits to customers. The method may be implemented by system which includes one or more computer systems, e.g., each including one or more processors, and one or more computer readable memory media which store program instructions executable by the computer system(s) to implement the method. Embodiments directed towards a computer readable memory medium which stores program instructions executable by the system to implement the methods described herein are also contemplated.

A specification of a custom circuit may be received from at least one first user. The specification may be received over a wide area network, such as the Internet. The specification may specify a design of the custom circuit. The custom circuit may in some embodiments include one or more custom circuits (PCBs), one or more systems on chips (SoCs), and/or one or more semiconductor devices. In some embodiments, the custom circuit may include one or more intellectual property (IP) blocks. The specification of the custom circuit may be provided via a web browser to a server hosting a web site.

Information regarding the custom circuit may be provided on a website, over the wide area network. According to various embodiments, the information provided might include the specification of the custom circuit, an image of a circuit diagram of the custom circuit, a file from a circuit designer application, or any of various other kinds of information for display for at least one second user over the wide area network. In some embodiments, one or more files may also be provided over the wide area network (e.g., on the website). For example, the file(s) provided for download might be executable by the custom circuit, e.g., in order to expand, modify, or otherwise affect the functionality of the custom circuit.

In some embodiments, user input may be received over the wide area network from at least one second user. The second user may browse the website to search for a desired custom circuit on the website via the user input. Once the user finds a desired custom circuit on the website, the user may be able to take further action with respect to the custom circuit.

In some embodiments, the custom circuit may include one or more portions which may be user-configured. For example, one or more settings, ranges, or other characteristics of the circuits might be configurable. Thus in some embodiments, user input may be received from at least one second user over the wide area network to configure at least a portion of the custom circuit. Thus, the user may specify a user-configured custom circuit in some embodiments.

At least one purchase order of the custom circuit (e.g., a user-configured custom circuit, in some embodiments) may be received from the at least one second user over the wide area network. The purchase order may include delivery information for the custom circuit. In some embodiments, the purchase order may also include payment information.

Delivery of the custom circuit may be configured based on the purchase order. In some embodiments, fabrication of the custom circuit may be specified based on the one or more purchase orders; in other words, in some embodiments the custom circuit may not be fabricated until it is purchased. Alternatively, a pre-fabricated stock of the custom circuit may be available in some embodiments. The custom circuit may be delivered according to the delivery information included in the purchase order.

The at least one first user may receive payment based on the at least one purchase order. In some embodiments, e.g., if the purchase order includes payment information, the method may include providing payment to the at least one first user based on the at least one purchase order. Alternatively, another way for the at least one first user to receive payment based on the at least one purchase order may be arranged.

Thus, embodiments of the invention may establish a medium which potentially provides entrepreneurial circuit designers most (or all) of the services necessary to generate a customer base, produce circuits, and distribute the circuits to the customers, and correspondingly potentially provides customers a website at which a variety of custom circuits from a variety of different designers may be available. The system and method may effectively form an online custom circuit marketplace. Such a single channel for both designer-entrepreneurs and customers should streamline the market for custom circuits, providing a better experience for both designer-entrepreneurs and customers. For example, using the online custom circuit marketplace may allow designer-entrepreneurs to focus on designing custom circuits that meet market demands without worrying about the extra time, money and sales experience that getting their designs to market would otherwise require. Similarly, the presence of a single online custom circuit marketplace at which numerous custom circuits are available may reduce the search time and cost for customers looking for a custom circuit.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an exemplary computer system according to one embodiment;

FIG. 2 is a block diagram of an exemplary computer system according to one embodiment;

FIG. 3 illustrates a distributed computing environment according to one embodiment;

FIG. 4 is a flowchart diagram illustrating a method for providing an online marketplace for custom circuits according to one embodiment;

FIG. 5 is a diagram illustrating communication flow for an online marketplace for custom circuits according to one embodiment;

FIG. 6 is a diagram illustrating experience flow of a partner working with an online marketplace for custom circuits according to one embodiment;

FIG. 7 is a diagram illustrating experience flow of a customer working with an online marketplace for custom circuits according to one embodiment; and

FIG. 8 is a diagram illustrating experience flow of an online marketplace for custom circuits working with partners and customers according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a PROM, EPROM, EEPROM, flash memory, or magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Circuit—A “circuit” or “circuit device” as used herein has its ordinary and accepted meaning in the art, and at least includes electronic components and connections between the components. Examples of circuits and circuit devices may include printed circuit boards (PCBs), integrated circuits (ICs) including system on chips (SoCs), and/or any of various semiconductor devices.

Circuit Diagram—The term “circuit diagram” as used herein has its ordinary and accepted meaning in the art, and at least includes a representation of a circuit including components of the circuit and connections between the components. A circuit diagram may alternatively be referred to as a circuit schematic, an electronic schematic, or an electrical diagram, according to various embodiments.

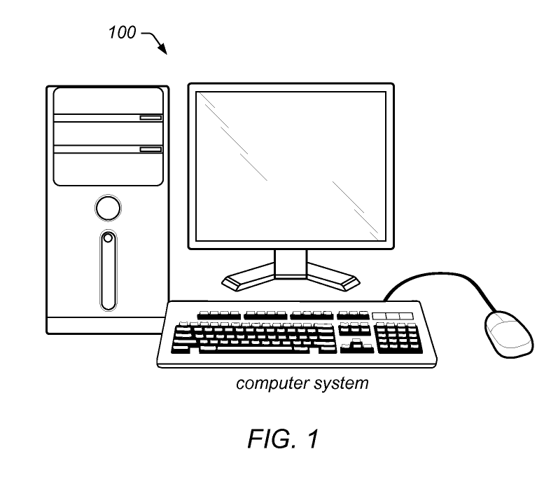

### FIG. 1—Computer System

FIG. 1 illustrates a computer system 100 which may be configured to implement part or all of the present disclosure according to some embodiments. As shown in FIG. 1, the computer system 100 may include one or more user input devices, such as a keyboard, mouse, and/or display device. The computer system 100 may include at least one memory medium on which one or more computer programs or software components according to one embodiment of the present invention may be stored. For example, the memory medium may store one or more programs which are executable to provide (part or all of) an online circuit marketplace according to any of the embodiments described herein. The memory medium may also store operating system software, as well as other software for operation of the computer system.

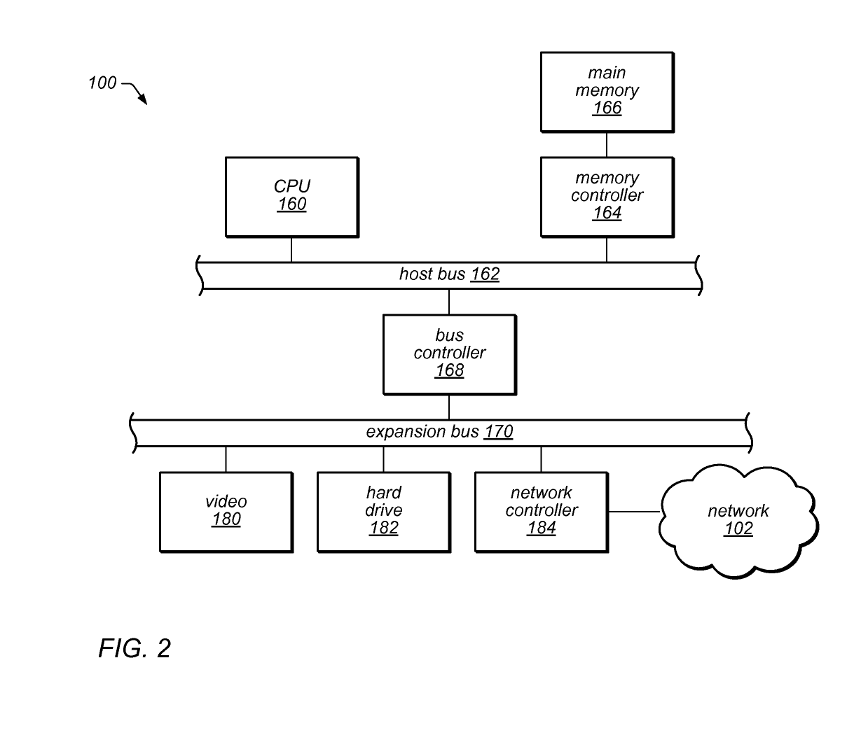

FIG. 2—Computer System Block Diagram

FIG. 2 is a block diagram representing one embodiment of a computer system such as the computer system 100 illustrated in FIG. 1. It is noted that any type of computer system configuration or architecture can be used as desired, and FIG. 2 illustrates a representative PC embodiment. It is also noted that the computer system may be a general purpose computer system, a server computer system, a mobile computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the one or more programs executable to implement embodiments of the disclosure. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 may include slots or connections for various devices. The computer 100 may further include a video display subsystem 180 and hard drive 182 coupled to the expansion bus 170. The computer 100 may also include a network controller 184 by which the compute 100 may connect to a network 102, which could be a local area network (LAN), a wide area network (WAN), or any kind of network.

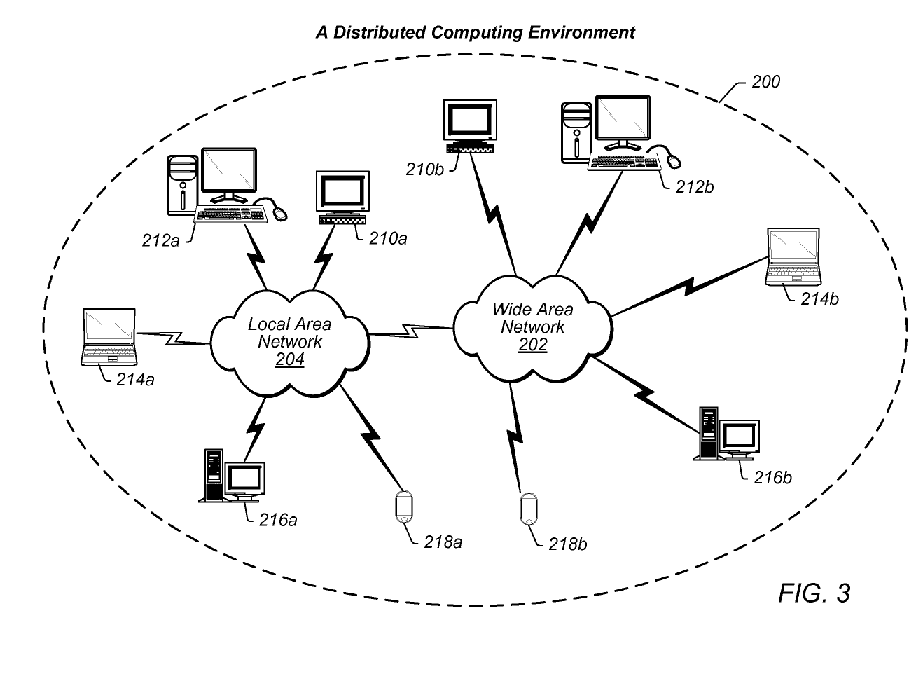

### FIG. 3—Exemplary Distributed Computing Environment

FIG. 3 illustrates an exemplary distributed computing environment 200, according to one embodiment. The distributed computing environment 200 may include a plurality of computer systems, (such as computer system 100 illustrated in FIGS. 1 and 2), which are interconnected through one or more networks (such as network 102 shown in FIG. 2). Although one particular embodiment is shown in FIG. 3, the distributed computing environment 200 may comprise a variety of heterogeneous computer systems and networks which are interconnected in a variety of topologies and which run a variety of software applications.

One or more local area networks (LANs) 204 may be included in the distributed computing environment 200. A LAN 204 is a network that spans a relatively small area. Typically, a LAN 204 is confined to a single building or group of buildings. Each node (i.e., an individual computer system or device) of the LAN 204 may include its own CPU with which it executes computer programs, and often each node may be able to access data and devices anywhere on the LAN 204. The LAN 204 thus allows many users to share devices (e.g., printers) as well as data stored on file servers. The LAN 204 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves). FIG. 3 illustrates a distributed computing environment 200 including one LAN 204. However, the distributed computing environment 200 may include a plurality of LANs 204 which are coupled to one another through a wide area network (WAN) 202. A WAN 202 is a network that spans a relatively large geographical area.

Each LAN 204 comprises a plurality of interconnected computer systems or at least one computer system and at least one other device. The computer systems and devices interconnected through the LAN 204 might include, according to various embodiments, one or more workstations 210a, personal computers 212a, laptop or notebook computer systems 214a, server computer systems 216a, or mobile computing devices 218a. Any of various other devices (e.g., printers) may also interconnect through LAN 204 in some embodiments. The exemplary LAN 204 shown in FIG. 2 includes one of each of these computer systems 210a, 212a, 214a, 216a, and 218a. In some embodiments, one or more of computer systems 210a, 212a, 214a, 216a, and 218a may be implemented as a computer system such as computer system 100 shown in FIGS. 1 and 2. The LAN 204 may be coupled to other computer systems and/or other devices and/or other LANs 204 through a WAN 202.

The distributed computing environment 200 may also include one or more computer systems which are connected to the distributed computing environment 200 through the WAN 202. As illustrated, the one or more computer systems might include one or more of a workstation 210b, a personal computer 212b, a laptop or notebook computer system 214b, a server computer system 216b, and/or a mobile computing device 218b such as a smartphone or personal digital assistant (PDA). In other words, the distributed computing environment 200 may optionally include one or more computer systems which are not coupled to the distributed computing environment 200 through the LAN 204. For example, the distributed computing environment 200 may include computer systems which are geographically remote. In one embodiment, the Internet may be included in WAN 202.

It is noted that although in some embodiments the method described herein may be implemented by a single computer system (e.g., any of the computer systems described in FIGS. 1-3), embodiments are also contemplated in which a plurality of computers may form a system configured to implement the method described herein. For example, one computer system could be used to host a website which receives custom circuit specifications from circuit designers, and on which information regarding custom circuits is provided, while another computer system could be used to receive purchase orders for the custom circuits, and still further computer system could configure delivery of the custom circuits. Thus, a system of interconnected computer systems could implement the method in one embodiment. Other arrangements are also contemplated.

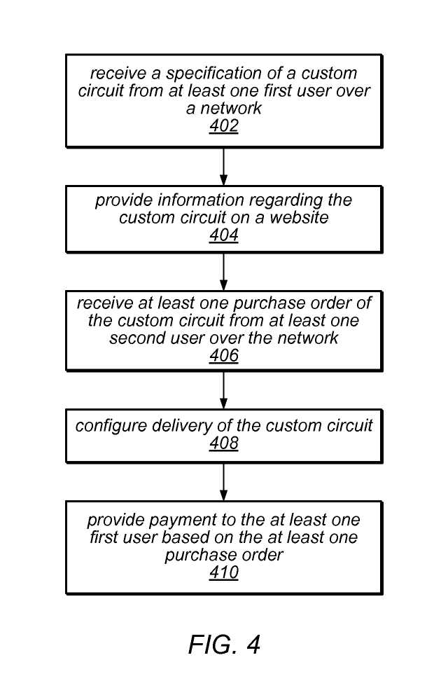

### FIG. 4—Flowchart Illustrating a Method for Providing an Online Marketplace for Custom Circuits

FIG. 4 is a flowchart illustrating a method for providing an online marketplace for custom circuits according to one embodiment. By providing a single source for most (or all) of the associated services that are necessary to generate a customer base, produce devices, distribute the devices to customers, and manage a revenue stream while maintaining a reasonable product price, the method may provide circuit design entrepreneurs a means to profitably market simple, low-cost circuits. The same factors will similarly benefit hobbyists and other potential niche customers by providing a single source with access to a wide range of relatively low-cost, simple circuits from a variety of designer-entrepreneurs.

The method shown in FIG. 4 may be used in conjunction with any of the computer systems shown in the above Figures, among other devices. For example, embodiments are contemplated which the method described herein is performed by a system including one or more computer systems (such as any of the computer systems shown in FIG. 3) to provide an online marketplace for various users over one or more networks (such as LAN 204 and/or WAN 202 shown in FIG. 3). In various embodiments, some of the method elements shown may be performed concurrently, in a different order than shown, or may be omitted. Additional method elements may also be performed as desired. As shown, this method may operate as follows.

In 402, a specification of a custom circuit may be received from one or more first users (e.g., designer-entrepreneurs) over a network (e.g., a wide area network). The specification may include an image of a circuit diagram of the circuit, a file from a circuit designer application, a description of the functionality of the circuit, and/or any of various other types of information regarding the circuit, according to various embodiments. The circuit itself may be any kind of circuit, e.g., a circuit that is custom-designed by a circuit design entrepreneur, and may include one or more printed circuit boards (PCBs), one or more systems on chips (SoCs), and/or one or more semiconductor devices, among other possible circuit types and circuit components. In some embodiments, the custom circuit may optionally or automatically also include one or more intellectual property (IP) blocks (also referred to as IP cores or logic cores), for example as part of a programmable hardware element (such as an FPGA) and/or a memory component (such as an EPROM). Embodiments are contemplated in which custom circuits designed by circuit design entrepreneurs for the online marketplace may typically be small, simple, and/or inexpensive circuits, typically ranging from 10 to 50 components; however, other embodiments are also contemplated in which the range of complexity, size, and cost of the circuits may be much larger (or smaller), and may include any number of components, as desired.

In some embodiments, e.g., in order to reduce cost, facilitate manufacturing, and/or improve availability, there may be one or more limits placed on a circuit designed by a circuit design entrepreneur and marketed on the online circuit marketplace. For example, in some embodiments, circuits may be limited to a set of standard circuit board size, such as 2×3 inch boards, 5×7 inch board, or other standard sized boards. Another possibility is that the possible components that may be used in the circuit design may be limited to some predefined component set, e.g., that is normally and quickly available from a circuit component distributor. Embodiments are also contemplated in which the online circuit marketplace is directed primarily to circuits designed using a particular circuit design application or set of circuit design applications, such as National Instruments' Multisim™ and/or Ultiboard™ products. However, the limitations described in this paragraph may not be required, and the disclosure as a whole should not be considered limited to such embodiments.

In some embodiments, a designer-entrepreneur who wants to market a custom circuit (e.g., which he has designed) via the online marketplace described herein may also provide any of a variety of other types of information and/or items to the online marketplace in addition to the specification of the custom circuit. For example, the designer-entrepreneur may enter into a legal agreement with the online marketplace, may provide payment to the online marketplace for service(s), and/or may provide any other types of information. A variety of arrangements are contemplated with regard to such information; for example, the one or more first users (e.g., designer-entrepreneurs) may communicate some or all of such information to the hosting computer(s) electronically, e.g., over the network, and/or may communicate some or all of the information to the hosting computer(s) in other ways; alternatively, some or all of such information may not be provided to the hosting computer(s), but may instead be communicated in person, in paper, by facsimile transmission, or electronically via any other means. Embodiments are also contemplated in which the specification of the circuit (and/or any other information) are provided by the designer-entrepreneur via an alternate means (i.e., not over the network) to an administrator of the online marketplace, who may then provide the specification (and/or the other information) directly to the hosting computer.

According to some embodiments, it may be desirable that a designer-entrepreneur perform some initial work in preparing a product (e.g., a custom circuit) before the product is marketed in the online marketplace. For example, embodiments are contemplated in which the designer-entrepreneur provides the basic circuit design(s), prototype verification, and pricing of a product or product line before the product or product line is listed in the online marketplace. This may assist in ensuring that each product listed in the online marketplace has undergone sufficient design validation and verification and serves its intended purpose.

In some embodiments, the online marketplace administrator(s) may also or alternatively perform prototype validation, provide pricing suggestions, or otherwise assist in the initial phase of establishing a product for the marketplace. For example, the marketplace administrator(s) may find it desirable to ensure that each product marketed on the online circuit marketplace functions as advertised, and/or is priced at a level sufficient to recover any expenses incurred in the process of marketing the product, such as fabrication expenses, shipping expenses, and/or marketplace maintenance expenses, among other possible expenses.

In 404, information regarding the circuit may be provided on a website. For example, the circuit may be listed in the online marketplace for purchase. The information regarding the circuit may include any of a variety of kinds of information; according to various embodiments, more or less information regarding each circuit listed may be provided, as desired. The information regarding the circuit could include, for example, the specification of the circuit (which could include an image of a circuit diagram and/or a file from a circuit designer application), a list of components used in the circuit, size information for the circuit, price information for the circuit, one or more suggested uses for the circuit, one or more names of designer-entrepreneurs and/or other contributors to the design and/or production of the circuit, and/or an estimated manufacture and/or delivery time of the circuit. In some embodiments, one or more images and/or files (e.g., for download) related to the circuit may be provided on the website. It will be noted that the above list of possible information regarding the circuit that could be provided on the website is exemplary only, and should not be considered limiting; as will be apparent to those skilled in the art, a great variety of possible information could be provided for any given circuit, as desired.

In some embodiments, the website may include functionality for users to browse for a desired circuit. For example, a user may be able to perform a search for keywords related to the desired circuit, to select categories and/or subcategories of circuits to view, scroll through one or more lists of circuits, and/or perform any other browsing related operations, in various embodiments. User input may accordingly be received over the network from a user (e.g., a customer) browsing the website to search for a desired custom circuit on the website in some embodiments.

In some embodiments, a custom circuit may include one or more user-configurable portions. In other words, one or more settings, ranges, or other characteristics of a circuit might be configurable. For example, in some embodiments, the value(s) (e.g., capacitance, resistance, etc.) of one or more components might be configurable by a user. In some embodiments, one or more components of a circuit may be selectable from a plurality of component choices. The custom circuit may also or alternatively be user-configurable in a variety of other ways, as desired. Thus, in some embodiments, user input may be received from a customer over the wide area network to configure at least a portion of the custom circuit, thereby specifying a user-configured custom circuit. For example, the user may be able to select among a number of different IP blocks for use in the circuit. It should also be noted that in some embodiments, the custom circuit may not be user-configurable, and may only be available in one configuration.

In some embodiments, a circuit may optionally or automatically include one or more logic cores. For example, a circuit might be designed to include one or more IP blocks, which a customer could select for purchase as part of the custom circuit. Embodiments are also contemplated in which purchase of one or more IP blocks is automatically included with purchase of a circuit.

According to various embodiments, a circuit designed to include one or more logic cores (such as IP blocks and/or open-source logic cores) may be pre-configured with the logic cores, or alternatively the logic cores may be available for the customer to configure the circuit with themselves. For example, embodiments are contemplated in which one or more files are available on the website which may be used to configure a circuit (e.g., a circuit including a programmable hardware element) with one or more logic cores. Embodiments are similarly contemplated in which one or more files are available on the website which may be executable by a circuit (e.g., a circuit including a processor). Such files may be available for free on the website, for purchase individually, and/or for purchase in combination with a particular circuit, according to various embodiments. Alternatively, or in addition, one or more such files may be delivered together with a purchased circuit, e.g., on a memory medium. Embodiments are also contemplated in which a circuit may be preconfigured with one or more logic cores and/or executable files, but may be re-configured at a later time, e.g., by means of one or more files available on the website in association with the circuit, or by any other means, as desired. Once a customer has selected a custom circuit and chosen their desired options (if any), the customer may be able to purchase the custom circuit, e.g., as described below.

In 406, one or more purchase orders of the circuit may be received from one or more second users (e.g., customers) over the network. The purchase order(s) may include delivery information for the custom circuit. For example, a user purchasing a circuit may provide information indicating where the purchased circuit should be delivered, such as a home address or a place of business. Alternatively, in some embodiments the delivery information could indicate that the user purchasing the circuit will pick up the circuit from a particular location.

The purchase order(s) may also include payment information. In some embodiments, the payment information may be received by the online circuit marketplace, e.g., to a secure server dedicated to financial transactions. Alternatively, in some embodiments, a third party (e.g., a party dedicated to performing secure financial transactions online) may receive the payment information, and may provide payment to the online circuit marketplace and/or the circuit designer/entrepreneur. Embodiments are also contemplated in which payment may be made directly to the designer/entrepreneur, either over the wide area network (e.g., through the website) or by another means.

In 408, delivery of the custom circuit may be configured. It will be noted that in some embodiments the method (e.g., as implemented by a system including one or more computers) may include configuring delivery of the custom circuit (e.g., setting in motion the process of delivering the custom circuit to a customer) as described below, e.g., by scheduling delivery-related tasks for completion, indicating to one or more users (e.g., administrators) that delivery of the circuit (and/or one or more specific delivery-related tasks) should be performed, or by other means, but may not include the actual carrying out of delivery of the custom circuit. For example, actual delivery may be carried out at least in part by one or more people and/or other systems. Alternatively, in some embodiments, the method may further include some or all of the actual delivery related functions.

In some embodiments, a stock of pre-fabricated custom circuits may be available. For example, in some embodiments, as part of listing a product on the website, an initial order for fabrication of a certain number of the products may be made, such that an inventory of a custom circuit will already exist at a time of purchase of the custom circuit. In this case, delivery of the custom circuit may include handling (e.g., packaging) and/or shipping the ordered custom circuit(s) from the inventory location to a location indicated by the delivery information, or even simply preparing the circuit for pick-up by a purchasing customer at a particular location.

Alternatively, in some embodiments, fabrication of a custom circuit may be specified based on a purchase order of a custom circuit. For example, a just-in-time inventory strategy may in some embodiments be employed, in which for example a circuit may not be fabricated until a purchase order is placed for that circuit. In some embodiments, then, one or more circuit components may be purchased and possibly delivered to an assembly location, and the custom circuit may be assembled and in some cases (e.g., if there is a programmable hardware element and/or processor/memory elements) configured, in addition to handling and shipping the custom circuit(s) to the location indicated by the delivery information (or preparing the circuit for pick-up by a customer).

In 410, payment may be provided to the one or more first users (e.g., the designer-entrepreneur(s)) based on the one or more purchase orders of the circuit. As noted above, various embodiments are contemplated with relation to payment arrangements. In a preferred embodiment, payment may be made by a customer to the online circuit marketplace (e.g., the system implementing the method) in exchange for a purchased circuit. The online circuit marketplace may track how many of a particular circuit are sold, and may make royalty payments (e.g., at regular intervals, or on a per-sale basis) to the designer entrepreneur based on each circuit sold. In other words, the system may receive payment information from a customer as part of a purchase order for a circuit, and the system may provide payment to the designer entrepreneur based on the purchase order. Numerous alternate embodiments are also contemplated, for example in which a customer makes payment directly to the designer entrepreneur (who might pay the online circuit marketplace for services), or in which a customer makes payment to a third party, which either provides payment to the online circuit marketplace (who might pay royalties to the designer-entrepreneur), or to the designer entrepreneur (who might pay the online circuit marketplace for services), or to both the online circuit marketplace and to the designer entrepreneur.

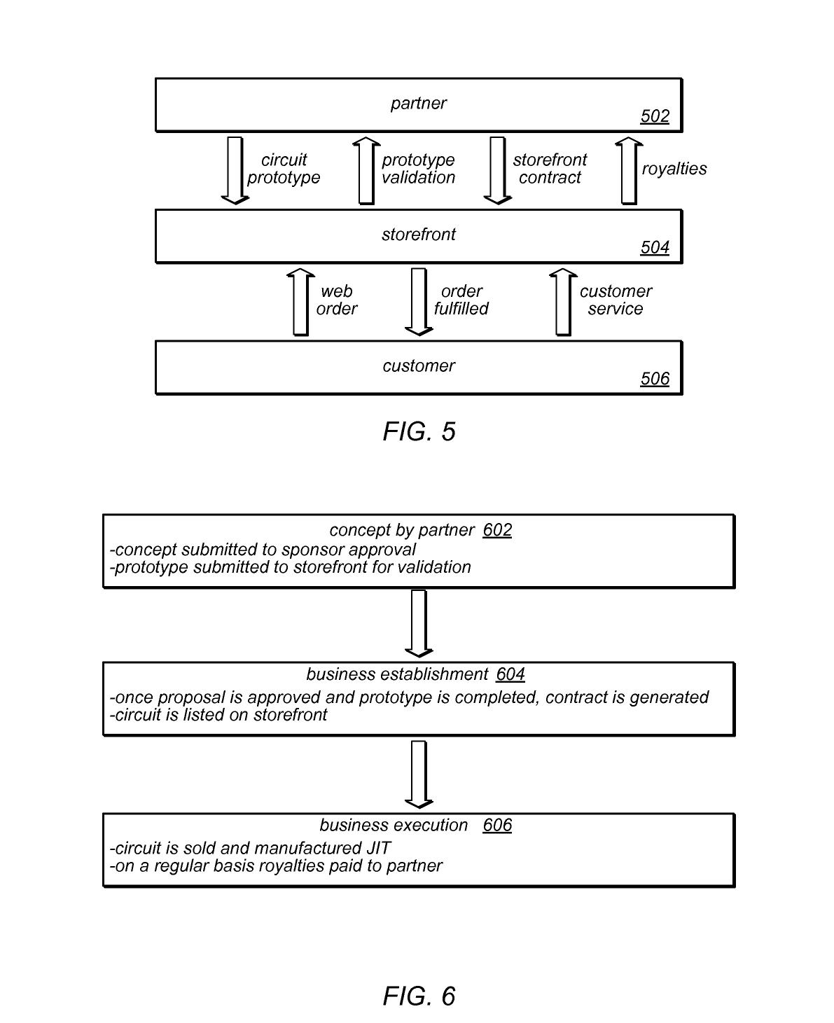

### FIG. 5—Communication Flow

FIG. 5 is a diagram illustrating flow between users of an online circuit marketplace and the online circuit marketplace according to one embodiment. It should be noted that although the interaction flow illustrated in FIG. 5 may illustrate one exemplary set of interactions, other types of interactions, and interaction flows, are also contemplated; accordingly, FIG. 5 and the description thereof provided below should not be considered limiting to the disclosure as a whole.

As shown in FIG. 5, there may be at least one partner 502 (e.g., a circuit design entrepreneur), a storefront 504 (e.g., the online circuit marketplace), and at least one customer 506. As shown, the storefront 504 may serve as an intermediary between the partner 502 and the customer 506.

The partner's 502 interaction with the storefront 504 may initially include the partner 502 submitting a circuit design and/or circuit prototype to the storefront. The storefront 504 may in some cases perform prototype validation to insure that the circuit functions as intended and serves its intended purpose, e.g., that the circuit is a viable product. Once the circuit is approved, the partner may enter into a contract (e.g., a legal contract) with the storefront 504. Such a contract may define terms of an agreement between the partner 502 and the storefront 504; for example, the agreement might set forth what services the storefront 504 will provide for the partner, what fees the partner 502 will pay to the storefront 504 in exchange for services, what royalty the storefront 504 will pay to the partner 502 for each circuit sold, and/or one or more other terms.

The customer's 506 interaction with the storefront 504 may include the customer 506 finding a desired circuit via the storefront 504 and ordering (e.g., via the website) the circuit from the storefront 504. The storefront 504 may then fulfill the order, for example including fabricating the circuit, configuring delivery of the circuit, and/or delivering the circuit to the customer 506. The storefront 504 may also provide customer service to the customer 506. For example, the storefront 504 may offer technical support with relation to purchased circuits, return options for damaged, defective or otherwise unsatisfactory products, assistance with delivery (e.g., shipping) problems, and/or other services to the customer 506.

### FIG. 6—Partner Experience

FIG. 6 is a diagram illustrating a typical experience flow of a partner (e.g., a circuit design entrepreneur) working with a storefront (e.g., an online circuit marketplace) according to one embodiment. In other words, FIG. 6 shows the key actions of and benefits to a partner working with a storefront as a circuit design entrepreneur according to one embodiment. It should be noted that although the experience flow illustrated in FIG. 6 may illustrate one flow of experiences for a partner, other experiences, and experience flows, are also contemplated; accordingly, FIG. 6 and the description thereof provided below should not be considered limiting to the disclosure as a whole.

As shown, in 602 the partner may produce a concept for a circuit. The concept may stem from any number of sources. The partner may have a need for a particular circuit for their own personal use, and may believe that others may feel a similar need. The partner may have observed or heard from others that a need exists for a circuit that fills a specific purpose. In some embodiments, a sponsor that requires or knows of a market niche for a particular kind of circuit may commission the partner to design such a circuit. Other reasons for conceptualizing a circuit are of course also possible. Once a circuit concept is developed, the partner may design a circuit according to the circuit concept. Once the circuit is designed, it may be determined whether the circuit will actually fulfill the need or purpose for which it was designed. The design, e.g., including a virtual prototype and/or a physical prototype of the circuit, may be demonstrated, and the circuit may be verified and/or validated. In various embodiments, the partner, the storefront, a third party, and/or a combination thereof may perform such design verification/validation for the circuit.

In 604, a business arrangement may be established with the storefront. Once a proposal (e.g., including circuit design, circuit pricing, and/or other factors) for a circuit is approved, a contract between the partner and the storefront may be generated. As previously described, such a contract may define terms of a business agreement between the partner and the storefront. The circuit may then be listed on the storefront, e.g., on an online circuit marketplace website.

In 606, the business arrangement may be executed. The circuit may be sold to customers by the storefront, in some embodiments implementing a just-in-time (JIT) inventory arrangement, and the partner may accordingly receive royalties for each circuit of their design sold, as for example according to the contract.

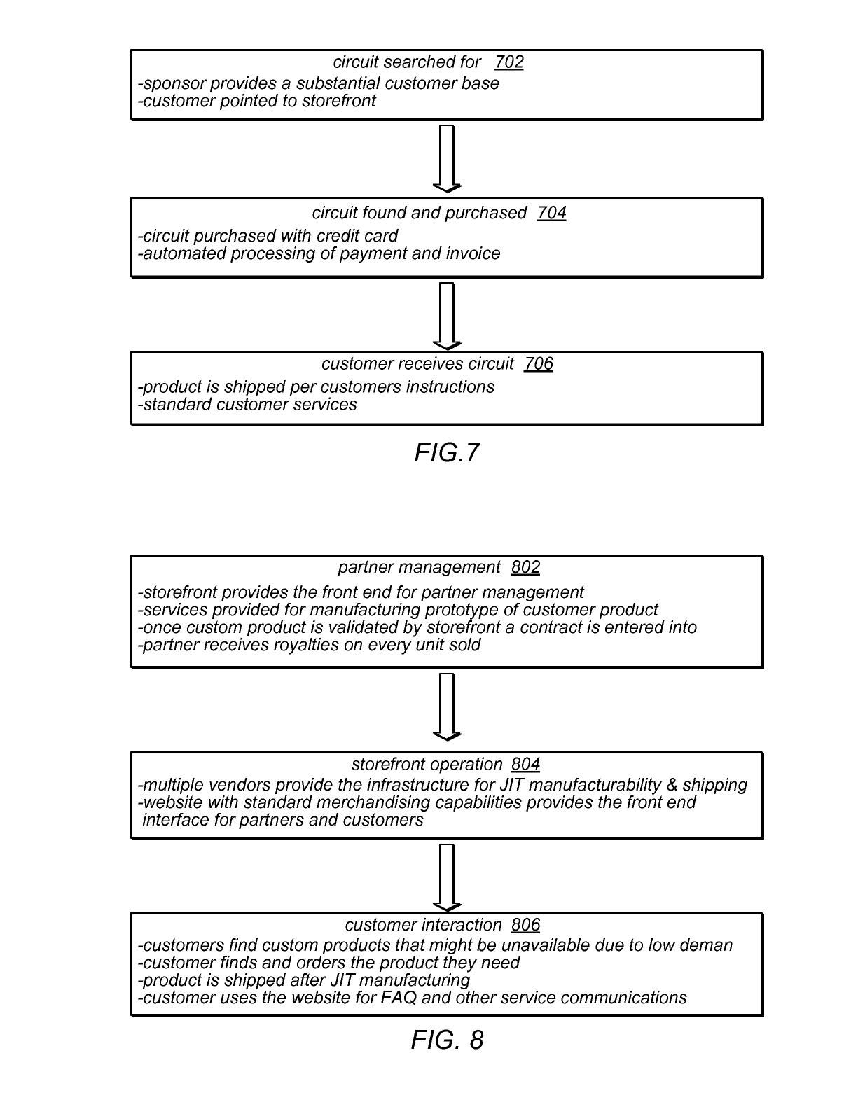

### FIG. 7—Customer Experience

FIG. 7 is a diagram illustrating a typical experience flow of a customer looking for a custom circuit according to one embodiment. In other words, FIG. 7 shows the key actions of and benefits to a customer purchasing from a storefront according to one embodiment. It should be noted that although the experience flow illustrated in FIG. 7 may illustrate one flow of experiences for a customer, other experiences, and experience flows, are also contemplated; accordingly, FIG. 7 and the description thereof provided below should not be considered limiting to the disclosure as a whole.

In 702, the customer may search for a circuit for a particular purpose. In some cases, it is envisioned that a company offering a product or line of products may sponsor the development of one or more associated circuits (e.g., as add-ons) for their product or product line. Such companies (“sponsors”) might thus provide a substantial customer base for a circuit design entrepreneur who designs a circuit for use in association with the company's product or product line. The company might direct its customers to the storefront at which the circuit (or circuits) are marketed. Thus in some cases, the customer may search for and find a desired circuit via a sponsor. In other cases, a customer may browse for and find a desired circuit on the storefront independently, e.g., for their own (e.g., hobbyist) purposes.

In 704, the customer may find and purchase a desired circuit. In some embodiments, the circuit may be purchased online, e.g., through the storefront, by credit card or another online purchasing means. The payment may be automatically processed and invoiced by the storefront. The customer may also provide delivery information at the time of purchase, including, for example, a shipping address, a shipping method (e.g., a carrier and/or a priority), and/or any special delivery instructions.

In 706, the customer may receive the purchased circuit. The circuit may be shipped to the customer (or more generally, to a location of the customer's choosing) according to the customer's instructions. The customer may also receive any of various typical customer services from the storefront, such as for example technical support with relation to purchased circuits, return options for damaged, defective or otherwise unsatisfactory circuits, assistance with delivery (e.g., shipping) problems, and/or other services.

### FIG. 8—Storefront Experience

FIG. 8 is a diagram illustrating a typical experience flow of a storefront interacting with circuit design entrepreneurial partners and customers according to one embodiment. In other words, FIG. 8 shows the key actions of and benefits to a storefront providing services to a circuit design entrepreneur and custom circuit products to customers according to one embodiment. It should be noted that although the experience flow illustrated in FIG. 8 may illustrate one flow of experiences for a customer, other experiences, and experience flows, are also contemplated; accordingly, FIG. 8 and the description thereof provided below should not be considered limiting to the disclosure as a whole.

In 802, the storefront may manage the partner's experience. The storefront may provide front-end services for the partner. In some cases, the storefront may provide prototype manufacturing, verification, and/or validation services for the partner. The storefront may enter into an agreement with the partner, providing marketing, copywriting, sales, and/or customer service to customers on behalf of the partner. In exchange, the storefront may receive payment for services from the partner from the sales price of each product sold, and/or may separately receive fees for services (such as marketing and copywriting) from the partner. The storefront may pay royalties to the partner for each product sold.

In 804, the storefront operation is described. In some cases, the storefront may interact with multiple vendors (e.g., component vendors, circuit board vendors, circuit assembly companies, shipping companies, etc) in order to manage manufacturing and shipping of circuits. The interactions may be managed according to a JIT inventory policy. The storefront may also include a website (or multiple websites), e.g., with standard merchandising capabilities, as a front end interface for interaction with partners and/or customers.

In 806, the storefront interaction with customers is described. The storefront may provide, by its agreements with circuit design entrepreneurs and streamlined operating methods, custom products that might otherwise be unavailable due to low demand, at reasonable prices. The storefront website may provide a user-friendly interface for customers to search for, find, and order their desired product(s) (e.g., circuits). The storefront may then ship purchased product(s) (e.g., after JIT manufacturing and/or shipping) to a customer's desired location for the customer's use. The storefront may also provide answers to frequently asked questions (FAQ) and provide other services to the customer via the website.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A network-based method for providing custom circuits to customers, comprising:
utilizing at least one computer to perform:
receiving a specification of a custom circuit from at least one first user over a wide area network, wherein the specification specifies a design of the custom circuit;
providing information regarding the custom circuit on a website, wherein said providing is performed over the wide area network;
receiving at least one purchase order of the custom circuit from at least one second user over the wide area network, wherein the at least one purchase order comprises delivery information for the custom circuit; and
configuring delivery of the custom circuit based on the at least one purchase order;
wherein the at least one first user receives payment based on the at least one purchase order.

2. The method of claim 1, wherein the custom circuit comprises one or more of:
one or more printed circuit boards (PCBs);
one or more systems on chips (SoCs); or
one or more semiconductor devices.

3. The method of claim 1, wherein said providing information comprises providing one or more of:
the specification of the custom circuit;
an image of a circuit diagram of the custom circuit; or
a file from a circuit designer application;
for display for the at least one second user over the wide area network.

4. The method of claim 1, further comprising:
providing one or more files for download over the wide area network, wherein the one or more files are executable by the custom circuit.

5. The method of claim 1, further comprising:
receiving user input from at least one second user over the wide area network browsing the website to search for a desired custom circuit on the website.

6. The method of claim 1, further comprising:
receiving user input from at least one second user over the wide area network to configure at least a portion of the custom circuit, thereby specifying a user-configured custom circuit;
wherein said configuring delivery comprises configuring delivery of the user-configured custom circuit.

7. The method of claim 1, further comprising:
specifying fabrication of the custom circuit based on the at least one purchase orders.

8. The method of claim 1, wherein the at least one purchase order comprises payment information, further comprising:
providing payment to the at least one first user based on the at least one purchase order.

9. The method of claim 1,
wherein the custom circuit comprises one or more intellectual property (IP) blocks.

10. A computer readable memory medium storing program instructions for providing custom circuits to customers, wherein the program instructions are executable to:
receive a specification of a custom circuit from at least one first user over a wide area network, wherein the specification specifies a design of the custom circuit;
provide information regarding the custom circuit on a website, wherein said providing is performed over the wide area network;
receive at least one purchase order of the custom circuit from at least one second user over the wide area network, wherein the at least one purchase order comprises delivery information for the custom circuit; and
configure delivery of the custom circuit based on the at least one purchase order;
wherein the at least one first user receives payment based on the at least one purchase order.

11. The computer readable memory medium of claim 10, wherein the custom circuit comprises one or more of:
one or more printed circuit boards (PCBs);
one or more systems on chips (SoCs); or
one or more semiconductor devices.

12. The computer readable memory medium of claim 10, wherein the program instructions for providing information regarding the custom circuit are executable to provide one or more of:
the specification of the custom circuit;
an image of a circuit diagram of the custom circuit; or
a file from a circuit designer application;
for display for the at least one second user over the wide area network.

13. The computer readable memory medium of claim 10, wherein the program instructions are further executable to:
provide one or more files for download over the wide area network, wherein the one or more files are executable by the custom circuit.

14. The computer readable memory medium of claim 10, wherein the program instructions are further executable to:
receive user input from at least one second user over the wide area network browsing the website to search for a desired custom circuit on the website.

15. The computer readable memory medium of claim 10, wherein the program instructions are further executable to:
receive user input from at least one second user over the wide area network to configure at least a portion of the custom circuit, thereby specifying a user-configured custom circuit;
wherein said configuring delivery comprises configuring delivery of the user-configured custom circuit.

16. The computer readable memory medium of claim 10, wherein the program instructions are further executable to:
specify fabrication of the custom circuit based on the at least one purchase order.

17. The computer readable memory medium of claim 10, wherein the at least one purchase order comprises payment information, wherein the program instructions are further executable to:
provide payment to the one or more first users based on the at least one purchase order.

18. The computer readable memory medium of claim 10,
wherein the custom circuit comprises one or more intellectual property (IP) blocks.

19. A system for providing custom circuits to customers, the system comprising one or more computer systems, wherein the system is configured to:
receive a specification of a custom circuit from at least one first user over a wide area network, wherein the specification specifies a design of the custom circuit;
provide information regarding the custom circuit on a website, wherein said providing is performed over the wide area network;
receive at least one purchase order of the custom circuit from at least one second user over the wide area network, wherein the at least one purchase order comprises delivery information for the custom circuit; and
configure delivery of the custom circuit based on the at least one purchase order;
wherein the at least one first user receives payment based on the at least one purchase order.

20. The system of claim 19, wherein the custom circuit comprises one or more of:
one or more printed circuit boards (PCBs);
one or more systems on chips (SoCs); or
one or more semiconductor devices.

21. The system of claim 19, wherein the system is further configured to provide one or more of:
the specification of the custom circuit;
an image of a circuit diagram of the custom circuit; or
a file from a circuit designer application;
for display for the at least one second user over the wide area network.

22. The system of claim 19, wherein the system is further configured to:
provide one or more files for download over the wide area network, wherein the one or more files are executable by the custom circuit.

23. The system of claim 19, wherein the system is further configured to:
receive user input from at least one second user over the wide area network browsing the website to search for a desired custom circuit on the website.

24. The system of claim 19, wherein the system is further configured to:
receive user input from at least one second user over the wide area network to configure at least a portion of the custom circuit, thereby specifying a user-configured custom circuit;
wherein said configuring delivery comprises configuring delivery of the user-configured custom circuit.

25. The system of claim 19, wherein the system is further configured to:
specify fabrication of the custom circuit based on the at least one purchase order.

26. The system of claim 19, wherein the at least one purchase order comprises payment information, wherein the system is further configured to:
provide payment to the at least one first user based on the at least one purchase order.

27. The system of claim 19,
wherein the custom circuit comprises one or more intellectual property (IP) blocks.
